(19) United States
(12) Patent Application Publication
(10) Pub. No.: US 2007/0244923 A1
(43) Pub. Date: Oct. 18, 2007

(54) Method and Device for Managing Objects of a Communications Network

(76) Inventor: Michael Frantz, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/660,224

(22) PCT Filed: Jul. 28, 2005
(86) PCT No.: PCT/EP05/53682

§ 371 Date: Feb. 15, 2007

(30) Foreign Application Priority Data
Aug. 20, 2004 (EP) 04019860.8

(51) Int. Cl. H04L 29/06

(52) U.S. Cl. 707/103 R

(57) ABSTRACT

In one aspect, a method for the simplified management of objects of a transport network, particularly for allocating and/or managing access rights to this object for a group of users is provided The objects are managed by network elements and can be based on different technologies. The access rights are allocated on a layer that is hierarchically above the layer of the network elements, particularly by evaluating an attribute transmission layer for the respective object and the respective group of users.

### CROSS REFERENCE TO RELATED APPLICATIONS

This application is the U.S. National Stage of International Application No. PCT/EP2005/053682, filed Jul. 28, 2005 and claims the benefit thereof. The International Application claims the benefits of European application No. 04019860.8 EP filed Aug. 20, 2004, both of the applications are incorporated by reference herein in their entirety.

### FIELD OF INVENTION

The invention relates to the management of networks, e.g. of communication networks, and refers especially to the allocation of access rights for a user or a group of users for specific objects of the network.

### BACKGROUND OF INVENTION

A number of elements, physical and/or logical resources, services etc. have to be managed in a communications network. In particular, it is necessary to define which users or user classes can access what resources and/or objects and what type of access this may be.

As part of a TMN (Telecommunications Management Network) based terminology, each network can be mapped in a network model that includes several hierarchical layers (also referred to as tiers in the physical sense), with the elements of the respective layers communicating via defined interfaces (e.g. Q3) with the respective elements of the layer hierarchically above it.

Each network consists of a number of network elements and a number of objects (also called managed objects). The objects include all logical and physical resources of the network. One or more objects are managed in a network element, with objects from different technologies (e.g. different transmission media) such as optical data transmission, telephony and different network technologies such as ATM, GSM or SDH) also being allocated to one and the same network elements. Network elements can vary in complexity and in particular include ports, termination points, performance management points, protection groups, etc.

As part of a management system for networks of the type described above, it is necessary to allocate specific access rights to the elements of the network and/or access rights for actions that can be implemented within the network to a user who accesses the network or an application of the network. Furthermore, the objects have to be managed.

### SUMMARY OF INVENTION

Up to now, objects were managed and access rights usually defined at the hierarchy level of the network elements. The increasing inclusion and support of new technologies in the networks and the increasing complexity of networks has meant that it is necessary for a network element to also be able to support different technologies. Therefore, the allocation of access rights at the level of the network element is no longer adequate. Because objects of different kinds are also controlled in a network element, it is necessary to further differentiate the allocation of access rights so that the basic technology of the objects in a network element can be taken into account when allocating access rights. A differentiation of this kind was not possible in the known allocation using the methods according to prior art.

The invention has therefore undertaken the task of indicating a way by means of which the management of objects and the allocation of access rights for objects of a communication network can also be automated and simplified for objects of different technologies.

The object is achieved by the features of the accompanying claims shown in the following and especially by a method, a device and a system for managing objects, especially for defining access rights for a class or group of users to at least one object that is at least allocated to a network element in the network, with the network element being able to support various technologies and with the management of the objects in general and the allocation of access rights in particular taking place at a hierarchy level of the network above the hierarchy level of the network elements, especially of the transmission layer.

Up to now, the allocation of access rights in particular took place directly for each network element according to the known methods. With the solution according to the invention, it is possible to achieve a refinement during the allocation and to also define the access rights separately for objects of one or more network elements. This can also take account of a granularity that is below that of a network element. Up to now this has not been possible.

The main application area of the inventive method is in the field of communication networks. Access rights are defined in that a status or a value of an attribute of the “transmission layer” hierarchy level is used for objects of a transmission network. The invention is, however, not limited to this application area and can also be used for similar structured computer networks that can be hierarchically modeled.

The inventive solution supports the definition of access rights for operator groups. Frequently, certain circles, groups or classes of users for which similar or identical access rights should apply can be defined. With telecommunication networks, it is, e.g. the case that access to certain applications should also be possible for a group of users that pay a fee for the use of a specific performance feature or features. According to the invention, the criteria used to allocate the users to a user class can also be set. Preferably, the definition of the access rights is optionally given relative to technology groups, in that the transmission layer is grouped according to different technology groups to which the individual objects can be allocated. Access rights can then be allocated for groups of objects. The advantage of this is that the number of definitions required can be substantially reduced.

It is, however, cumulatively (in certain cases) or as an alternative, also possible for the access rights not to be allocated for a user class but instead for individual users. This is, for example, useful for relatively small networks. Normally, the user class covers a number of users.

The inventive solution refers to the definition of access rights. The term “definition” should be generally understood to mean all actions in conjunction with access rights, especially the allocation, control or monitoring and/or management of access rights.

In the preferred embodiment of the invention, the access rights are automatically defined. The access rights that should apply for which status or value of the “transmission layer” attribute can be preset. If a new object is now added to the network it is then not necessary to define the rights for this object (manually so to speak) but instead the allocation can be automatically determined by means of the value of the attribute. This on the one hand increases the convenience of this system and on the other hand avoids sources of errors due to incorrect allocation of access rights.

If the configuration and/or settings of the network change, e.g. due to changes of objects and/or network elements, then, according to the invention, the definition of the access rights takes place dynamically in that the value of an allocated attribute is automatically assessed. The flexibility of the system can thus be increased.

In a preferred development of the invention the network element or network elements can be operated by different end-to-end applications.

The invention generally relates to a simplification of all actions that arise in conjunction with the objects and especially refer to the management of objects, the definition and the allocation and/or management of access rights to the objects. Therefore the inventive method includes all management tasks that arise and must be implemented with necessary actions in conjunction with the objects, and especially their access rights.

The processing according to the invention with regard to objects at a hierarchically higher level has the advantage that the many individual processes per objects are no longer necessary.

The inventive forms of the method described above can also be embodied as a computer program product with a medium that can be read by a computer and with a computer program and associated program code means, with the computer being activated to perform the inventive method described above after the computer program has been loaded.

An alternative solution to the task is a storage medium that is designed for storing the computer-implemented method described above and can be read by a computer.

Additional, advantageous embodiments are given in the dependent claims.

### BRIEF DESCRIPTION OF THE DRAWINGS

The following detailed illustrated description deals with exemplary embodiments including their features and other advantages but these are not to be regarded as limiting. The drawing is as follows:

FIG. 1 A flow diagram of a preferred form of embodiment according to the invention.

### DETAILED DESCRIPTION OF INVENTION

A distinction is made between different layers of a communication network depending on the choice of abstraction level. The transport network or transmission layer network refers to the lowest layer and relates among other things to the physical routing of optical fibers and to switching devices and other elements.

The communication network depicted in a layer model includes a number of network elements NE and a number of objects O. The objects O represent all logical and/or physical resources of the network and, for example, include ports or PTPs, TCPs, (Termination on Connection Points), TTPs (Trail Termination Points), DXC (Digital Cross Connects), point-to-multipoint elements and protection groups etc.

Depending on the modeling, all objects O or only a selection of objects O in one or more network elements NE can be managed.

Each object O has its attribute, by which it is named, that serves for identification. According to the invention, for all objects O that can be uniquely allocated to a transmission layer TL the access rights to these objects O can be automatically allocated. For the remaining objects O that cannot be allocated, or not uniquely allocated, to a transmission layer, such as cards or other equipment, a preset can be used so that these objects O are dealt with uniformly for all users and in particular are visible for all users so that each user has access to these objects O.

If the user is, for example, limited with respect to certain transmission layers, the user can also access only the objects O of these (authorized) transmission layers.

Connection-oriented transport protocols and transport networks such as ATM (Asynchronous Transfer Mode) or SDH (Synchronous Digital Hierarchy) can be used for the data traffic. SDH is a purely transport network and transports the data to be transmitted in something called virtual containers (e.g. VC3, VC4, VC12).

The individual network levels, layers or hierarchies can communicate with each other mainly through standard interfaces. Where there are increased demands on the transport network, e.g. where there is mixed data and voice traffic, the management of the basic resources and therefore also the allocation and management of the access rights to these resources becomes ever more important. The invention also in this case offers an appropriate solution that is independent of the type of individual network elements NE with regard to the future inclusion of new other technologies in the network elements NE.

If it is necessary for the configuration of the network elements that new objects O and/or new network elements NE be included in the transport network (e.g. new PTPs, CTPs, TTPs, CCs, PMPs etc), then according to the invention, the allocation for the access rights to these elements for a selected group of users takes place automatically by the evaluation of the transmission layer TL attribute for the respective object O.

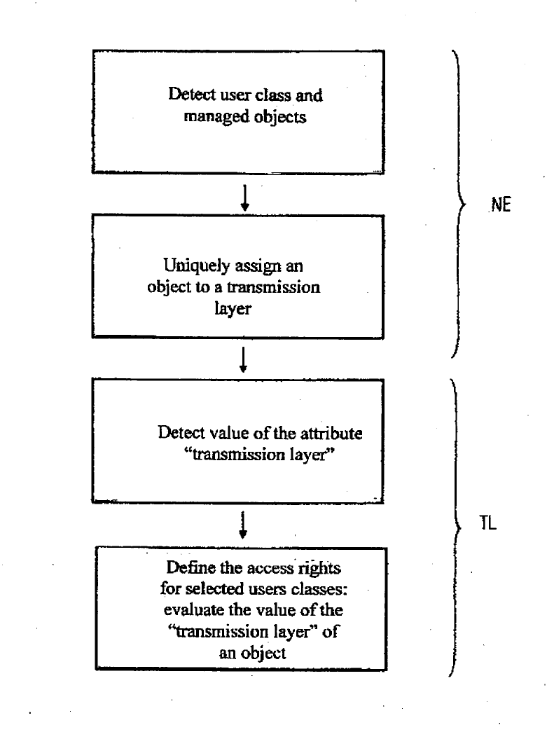

The sequence of the inventive method using a preferred embodiment of the invention is described in the following by reference to FIG. 1.

In a first step, a group of users for whom the access rights are to be allocated is determined. In this case it is possible for the allocation to be only for individual users, and therefore the user class then consists only of this one user, or for all users or a selection of users.

Then in a next step, the objects O that can be uniquely allocated to a transmission layer TL are identified and can therefore be the basis for the allocation of access rights.

Preferably, the first two steps take place at the hierarchy level of the network elements NE. This is identified by the reference character “NE” after the braces in FIG. 1. The succeeding steps are, according to the invention, performed at a higher-level hierarchy, i.e. the level of the transmission layer TL. This is marked with the reference character “TL” after the two lower sequence elements in FIG. 1.

After the value of the “transmission layer” TL attribute or a name uniquely allocated to the respective transmission layer has been determined, the access right can be defined.

This takes place in that the determined value of the “transmission layer” attribute TL for the respective object O is evaluated. The determined value can be referenced, by means of a look-up table or by access to a database, to the corresponding access rights and these are then automatically allocated.

The attribute can have a different name in other models but always defines the transmission layer that can be of a purely logical or physical nature. The information of the attribute referencing the object O is used according to the invention for the definition of the access right.

A very large network with, for example, more than 500,000 2-Mbit/s connections, requires a high number of network elements NE with different functionality and technology (e.g. ISDN, GSM, ATM, SDH etc). The number of transmission layers can be approximately 100. The management of individual objects O (the number of which can amount to millions for a relatively large network), the definition of the access rights with respect to the objects O and the management of the access rights can be enormously simplified according to the invention in that each individual object no longer needs to be addressed at the level of the network elements NE, but instead the objects can be referenced via the attribute in the hierarchically higher transmission layer.

FIG. 1 shows the main steps, according to a preferred embodiment of the invention, that of course need not necessarily be performed in this sequence.

The device according to the invention and the system according to the invention refer to an access module that is designed to perform the referencing method described above and, in particular, no longer addresses the objects directly but instead only indirectly through the value of the attribute.

1.-10. (canceled)

11. A method for managing a definition of an access right to an object allocated in a network element in a network, with the network element being able to support various technologies, comprising:
managing an object for a network element, the object for a hierarchy layer of the network that is at hierarchal layer above a physical layer or a data layer.

12. The method as claimed in claim 11, wherein hierarchy layer is a transmission layer and the object is of a transmission network.

13. The method as claimed in claim 12, wherein the access right is defined such that a value of an attribute of a transmission layer is evaluated for the transmission network object.

14. The method as claimed in claim 12, wherein the definition of the access right is chosen relative to the technology groups to which the object can be allocated.

15. The method as claimed in claim 14, wherein the definition of the access right includes an allocation, a control or monitoring of access rights.

16. The method as claimed in claim 14, further comprises automatically defining the access right.

17. The method as claimed in claim 14, further comprises dynamically defining the access right.

18. The method as claimed in claim 14, further comprises allocating the object prior to the defining the access rights.

19. The method as claimed in claim 14, wherein the access rights are defined for a group of users according to pre-configurable parameters.

20. The method as claimed in claim 14, wherein the network element is operated by different end-to-end applications.

21. A device having a management of objects, comprising:
a transmission layer object for a transmission layer of the network; and
an access right defined such that a value of an attribute of the transmission layer is evaluated for the transmission network object.

22. The device as claimed in claim 21, wherein the definition of the access right is chosen relative to the technology groups to which the object can be allocated.

23. The device as claimed in claim 14, wherein the access right is automatically defined.

24. The device as claimed in claim 14, further the access right is dynamically defined.

25. A system for a management of objects, comprising:
a plurality of network elements, at least one of the network elements having:
a transmission layer object for a transmission layer of the network, and
an access right defined such that a value of an attribute of the transmission layer is evaluated for the transmission network object.

26. The system as claimed in claim 25, wherein the definition of the access right is chosen relative to the technology groups to which the object can be allocated.

27. The device as claimed in claim 25, wherein the access right is automatically defined.

28. The device as claimed in claim 25, further the access right is dynamically defined.
